(19) United States
(12) Patent Application Publication
(10) Pub. No.: US 2002/0092760 A1
(43) Pub. Date: Jul. 18, 2002

(54) Water purification device

(76) Inventor: Eric Sanford Johnson, Houston, TX (US)

Correspondence Address: Eric Johnson, P.O. Box 981041, Houston, TX, 77098, US

(21) Appl. No.: 09/760,680

(22) Filed: Jan. 16, 2001

(51) Int. Cl. C02F 1/04

(52) U.S. Cl. 202/185.5; 203/10

(57) ABSTRACT

A water purification device comprises a unitized self regulating water distillation unit for processing drinking water. The distillation system is simple, rugged, and inexpensive to install, operate, and maintain. Two internal float switches in combination with an in-line, normally closed water supply valve and with an internal and always submerged heating element that are controlled by an electrical circuit including two electrical relays that when effectively combined enable water to be distilled through an air-cooled condensing coil housed in a compact unitized body. A mechanical insulation barrier is also provided, insulating the exterior of the device from the heat of the distillation process as well as internally directing the heat generated by the distillation process so that may be exhausted. Water may therefore be processed easily and routinely on a daily basis with a minimal amount of effort, cost, and maintenance by the owner or owners of such a system.

### BACKGROUND OF THE INVENTION

1. Field of Invention

The present invention relates to an apparatus for the purification of water by the distillation process for use as drinking water.

2. Description of Prior Art

One of the unfortunate results of the advancement of modem civilization to underdeveloped areas of the world is the increasing demand for pure drinking water. Unfortunately, industrialization often places unprecedented demand on the water supply, while simultaneously spoiling much of the potable water which is available.

Many solutions to the problem of purifying water for drinking have been proposed. Almost all solutions thus far advanced have been directed to large scale systems, in order to provide large quantities to large populations. While such systems are desperately needed, there also remains a need for small, inexpensive, simple to use systems for individual or family use.

Among the solutions offered for the purification of water are filtration, chemical treatment, settlement techniques, and distillation. The present invention is directed to a refinement of the distillation method, and is specially adapted for small, compact, unitized systems for the distillation of enough drinking water for one or a few days for an individual or a family.

Distillation units are described in U.S. Pat. Nos. 4,622,102 and 4,943,353, specifically relating to automatic controls and float control respectively. The systems described in these patents operate on a similar principal to the present invention, but are unnecessarily complex and therefore expensive. The systems are modular in design, and not unitized, and require a large horizontal area to operate. In addition, the float switches and control components are of less efficient mechanical design and result in difficulty to configure a small and compact unit that is totally unitized and self contained. In the current invention, the floats and switch are internally mounted and combined through a relay system to a heating element that is constantly submerged in water. Further, each of the systems is vertically supported from below, either on a platform or pedestal legs.

Thus, there remains a need for a small, compact unitized system in which all essential components of a distillation unit are included in a single form factor. The system should be efficient to maximize the thermal energy consumed, and should mount on a side or from above so that useful counter space is maximized.

### SUMMARY OF INVENTION

The present invention addresses these and other needs in the art by providing a convenient way for the user to make purified water for everyday consumption by incorporating more recently designed and improved electrical components into a unique and improved water still configuration that is totally unitized in its design.

The still of this invention was specifically designed for simplicity of construction and operation, eliminating extraneous or unduly complex components. The still comprises a reservoir adapted to hold a quantity of water to be purified, such as for example 1-3 gallons of water. Float switches inside the reservoir include reed switches incorporated internally in the float body. The float switch provides control functions with an in-line, normally closed water supply valve and with an internal, always submerged heating element. In turn, these components are controlled by an electrical circuit comprising two electrical relays that enable water to be distilled through an air cooled condensing coil housed in a compact unitized body.

The unitized body of the apparatus provides a mechanical insulation barrier from the heat of the distillation process as well as internally directing the heat generated by the distillation process so that it may be exhausted. This combination of components in the design of this water purification device for drinking water allows water to be processed easily and routinely on a daily basis with a minimum effort, cost, and maintenance.

These and other features of the invention will be apparent to those of skill in the art from a review of the following detailed description along with the accompanying drawings.

### BRIEF DESCRIPTION OF THE DRAWINGS

FIG. 1 is a perspective view of the apparatus in partial cutaway.

FIG. 2 is an external perspective view of the apparatus

FIG. 3 is an electric circuit illustrating various power and control aspects of the apparatus.

FIG. 4 is a perspective view of the apparatus in partial cutaway to illustrate the insulating air gap surrounding all the hot components of the apparatus.

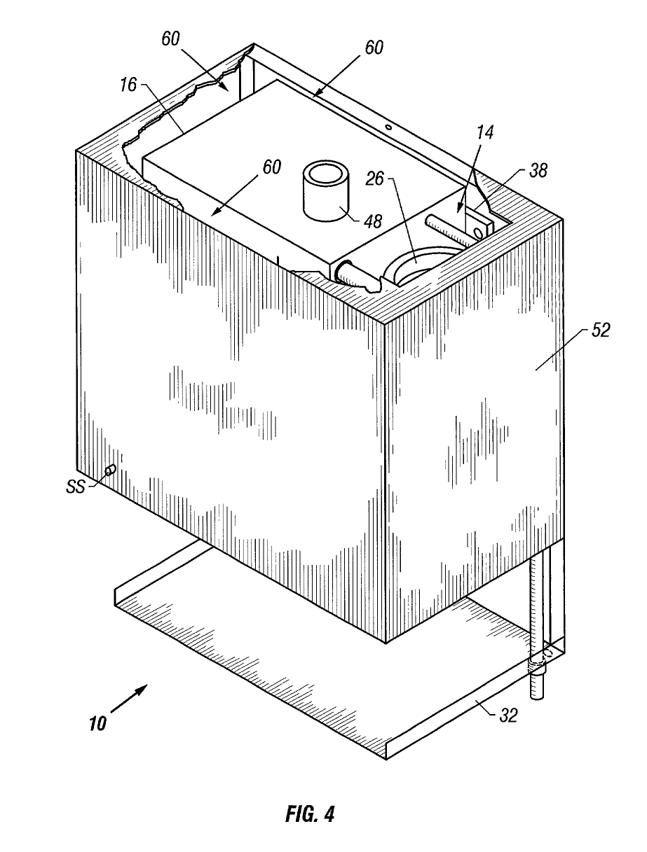

### DESCRIPTION OF A PREFERRED EMBODIMENT

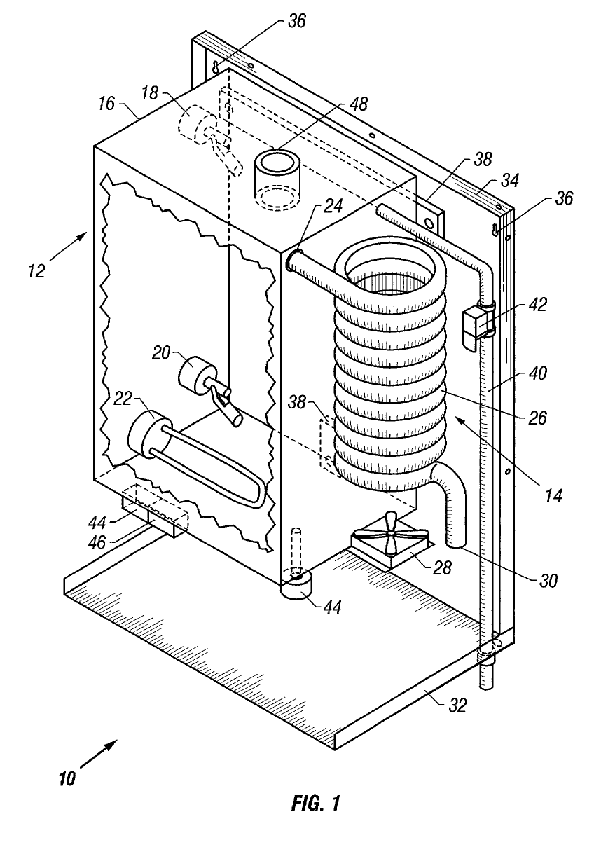

FIG. 1 depicts the preferred arrangement of the various components of the water purification device 10 of the present invention. The water purification device 10 comprises a distillation unit or boiler 12 on the left of FIG. 1 and a condensing unit 14 on the right side. This condensing chamber 14 contain the condensing coil 26 and the cooling fan 28. A feature of the present invention is that the components of the distilling apparatus 10 are unitized. As used in this specification, the term “unitized” refers to the feature that all the working components come as a unit, and for operation of the apparatus 10, all that remains in coupling the apparatus 10 to electrical power, and a source of water to be purified. The source of the water to be purified may be by hose coupling or manual fill, as described in further detail below.

The distillation unit 12 comprises a reservoir 16 to retain a quantity of water to be purified, and is preferably made of a durable material such as stainless steel. Within the reservoir 16 are mounted an upper float switch 18 and a lower float switch 20 which are placed within the reservoir 16 to maintain control of the water level (both high and low) during the water purification process. The float switches 18 and 20 may be LS-7 Series switches, available from Gems Sensors Inc., Plainsville, Conn., or any other appropriate fluid level-type switch.

The distillation unit 12 includes a heating element 22 to raise the temperature of the water in the reservoir to above the boiling point to thereby generate steam. The steam exits the distillation unit through an out port 24 and enters a condensing coil 26. The condensing coil is preferably made of stainless steel or other corrosion resistant material which also exhibits a low thermal resistance. Steam in the condensing coil 26 is cooled by ambient air forced around the coil 26 by a cooling fan 28. Cooling the steam causes it to condense to pure water, which exits the coil 26 at an outlet 30. Any convenient container (not shown) may be be placed at the outlet 30 and upon a receiver support plate 32 to collect the pure condensate.

The receiver support 32, in the form of a shelf, is integrally formed with a mounting bracket 34 to permit the distilling apparatus 10 to be mounted to a vertical wall, for example, with mounting holes 36. An opposing top (not shown) may also be included to permit mounting of the distilling apparatus 10 from the top. In either case, the apparatus 10 is preferably mounted up off counter space to save room. The mounting bracket thus supports the distillation unit 12 and is adapted to hold a condensate receiver on receiver support 32 to collect the purified process water being condensed by the coil 26.

The distillation unit 12 is attached by mounting tabs 38 to the mounting bracket 34. The mounting tabs 38 are preferably formed of 0.187″-0.25 ″ bar stock and welded to the reservoir 16. The mounting tabs serve the additional important feature of holding the reservoir 16 a safe distance from the Mounting bracket 34, i.e. and insulating air space 60 around the hot components of the system, so that a minimum amount of heat from the reservoir is conducted to the exterior of the distilling apparatus 10.

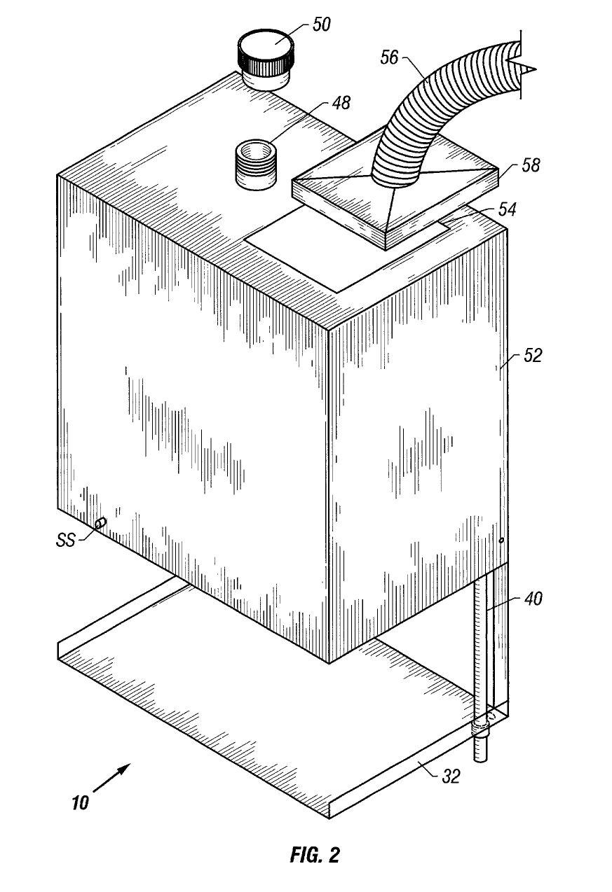

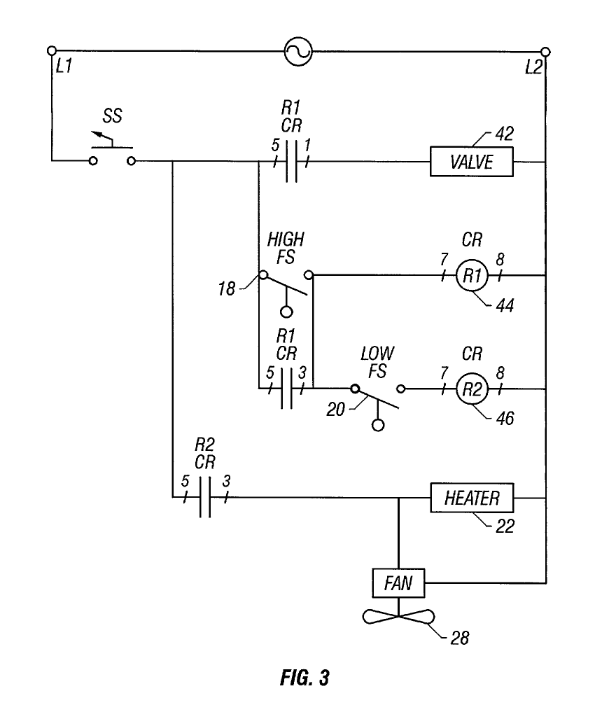

The distillation unit 12 also may include a supply hose 40 to supply water for purification to the reservoir 16. The water being supplied to the reservoir is controlled with control valve 42 in the supply hose 40. The control valve 42 is operated by the float switch 18 and float switch 20, described below in greater detail with regard to FIG. 3. The control valve 42, operated by float switches 18 and 20 maintains the proper unpurified water level in the reservoir for processing through the coil 26. The distillation unit 12 is also provided with a drain 44 for the draining of unprocessed water in the purification process to aid in the ease of maintenance and cleaning of the system. The distillation unit 12 may also include a manual fill orifice 48 and a cap 50 (FIG. 2) to aid in the cleaning or to manually fill the reservoir.

The water purification process is effected in the invention by filling the distillation unit 12 through the unpurified water supply line 40 and valve 42 controlled by the normally open float switch 18 and normally open float switch 20. Now referring to FIGS. 1 and 3 together, when an on/off switch SS is depressed (See also FIG. 2 for switch SS), the supply valve 42 (which is normally closed) is energized and thereby opened. Water is thus supplied to the reservoir through the now open valve 42 until the water level reaches the float valve 18. When the reservoir is full to the level of the flow switch 18, the float switch 18 shuts and a pair of relays 44 and 46 are picked up. This action de-energizes the supply valve 42 causing it to shut.

This action also provides power to the heating element 22 and the cooling fan 28, thereby processing the water which is condensed and collected from the coil 26. When the water contained in the reservoir 16 is processed to the point where the level reaches the lower float switch 20, the heating element 22 and the fan 14 are de-energized, and the heating element 22 is left submerged in residual water remaining in the reservoir. The residual water then may be drained out of the reservoir through the drain 44 so that scale build up will be minimal and thereby easing the maintenance of the invention. The float switch 18 and the float switch 20 are unitized switches that consist of internal reed switches enclosed in the body float, which simplifies the overall design of the control mechanism.

FIG. 2 depicts the exterior of the apparatus 10 in perspective. A cover 52 is attached on mounting bracket 34 to surround the three vertical sides of the apparatus (other than the backside covered by the mounting brackets), as well as the top of the unit. The cover 52 is attached in a spaced-apart relation to the components within to provide an insulating air pocket 60 around the hot components inside. Thus, the components are all assembled to form a unitized structure, thereby making the unit 10 self contained and easy to mount on a wall or set on or underneath a designated spot for use.

As previously described, when the cover 52 is attached to the mounting bracket 34, there is an air space 60 around all surfaces of unit which provides a mechanical insulation barrier from the generated heat. The cover 52 includes an opening 54 for airflow from the fan 28 so that a vent hose 56 with an easily removable plenum 58 can be used to exhaust or remove and direct the heat produced by the distillation process to an outside area in which the distillation unit is being used or to capture the heat for recycling.

Note that with the cover 52 installed, the hot components associated with the reservoir 16 are surrounded by an insulating air space 60, and that the coil 26 is located in a chamber 14 with an open bottom, all within the cover 52. On the other hand, the fill port 48 and the drain line 44 are easily accessible with the cover 52 remaining installed. For any other sort of maintenance to be performed on the unit, the cover 52 may be removed providing access to all the functioning components of the system. Further, the heater element 22 and the float switches 18 and 20 are each mounted in individual penetrations into the reservoir for ease of replacement.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. A unitized water purification device comprising:
a. a reservoir adapted to retain a quantity of water to be purified;
b. a heating element to raise the temperature of the quantity of water to at least the boiling temperature to thereby generate steam;
c. a top float switch to activate the heating element when the water level in the reservoir reaches the top float switch;
d. a bottom float switch to de-activate the heating element when the water level in the reservoir reaches the bottom float switch;
e. a condenser to receive steam from the reservoir and to condense the steam to purified water; and
f. a backplate on which the reservoir is mounted; and
g. a cover mounted around the reservoir and the condenser in spaced-apart relation from the reservoir and the condenser.

2. The device of claim 1, further comprising:
a. a mounting strip between the backplate and the reservoir, the blackplate defining a thickness; and
b. an air space between the reservoir and the backplate determined by the thickness of the mounting strip.

3. The device of claim 1, further comprising a hose connection from a source of water to be purified and the reservoir.

4. The device of claim 3, further comprising a valve in the hose connection.

5. The device claim 4, further comprising a manual actuation control switch to open the valve.

6. The device of claim 5, wherein the shutting of the valve is controlled by the top float switch.

7. The device of claim 1, wherein the bottom switch is located inside the reservoir at a vertical position higher than the heating element.

8. The device of claim 1, further comprising a fan to force ambient air around the condenser.

9. The device of claim 8, wherein the cover defines a volume with an open bottom, and wherein the fan is positioned in the open bottom.

10. The device of claim 1, further comprising a horizontal receiver support plate extending from the back plate.

11. The device of claim 1, further comprising a manual fill port in the reservoir.

12. The device of claim 1, further comprising a drain port from the reservoir.

13. The device of claim 4, wherein the valve is located inside the cover.

14. The device of claim 1, further comprising
a. a cover top over the reservoir and the condenser, the cover top defining an opening; and
b. an exhaust vent hose coupled to the opining to carry away heat from the condenser.

15. The device of claim 14, wherein the opening defines a plenum.
